(19) United States
(12) Patent Application Publication
(10) Pub. No.: US 2016/0267503 A1
(43) Pub. Date: Sep. 15, 2016

(54) SYSTEM AND METHOD FOR PREDICTING SALES

(71) Applicant: SALESPREDICT SW LTD., Netanya (IL)

(72) Inventors: Yaron Zakai-or, Kfar Haim (IL); Kira Radinsky, Zichron Yaakov (IL)

(21) Appl. No.: 14/902,391

(22) PCT Filed: Jul. 1, 2014
(86) PCT No.: PCT/IL14/50593

§ 371 Date: Dec. 31, 2015

Related U.S. Application Data
(60) Provisional application No. 61/841,583, filed on Jul. 1, 2013.

(51) Int. Cl. G06Q 30/02; G06N 99/00; G06F 17/30

(52) U.S. Cl. CPC G06Q 30/0202; G06F 17/30539; G06N 99/005

(57) ABSTRACT

A system for automatically generating predictions and salesmen-recommendations relating to sales, the system comprising at least one processor configured to: receive customers' historical sales data relating to one or more previous sale attempts wherein the customers historical sales data includes two or more data fields; receive at least one indication of at least one sale outcome relating to at least one of the sale attempts; for at least a given data field of the data fields, automatically determine possible values thereof; and based at least on the customer's historical sales data, the given field's possible values and the at least one indication, generate a prediction model useable for customer-based predictions.

### REFERENCE TO CO-PENDING APPLICATIONS

Priority is claimed from U.S. Provisional Application No. 61/248,521, filed Jul. 1, 2013, which is incorporated herein by reference.

### TECHNICAL FIELD

The presently disclosed subject matter relates to the field of sales prediction.

### BACKGROUND

Today, sales automation is mostly concentrated around data storage, better data entry, and the social aspects of sales. However, very few efforts have been made in the analysis of the data entered into the data storage. Moreover, very few have attempted to leverage the information found in those systems in order to improve the sales cycle and predict its future outcomes. The few solutions that do perform these kinds of tasks usually lack the right information needed for those types of predictions, require long installation and implementation cycles and require human intervention in the prediction process.

There is thus a need in the art for a new method and system for predicting sales.

References considered to be relevant as background to the presently disclosed subject matter are listed below. Acknowledgement of the references herein is not to be inferred as meaning that these are in any way relevant to the patentability of the presently disclosed subject matter.

Data Mining for Automated Evaluation of Sales Opportunities (by Jamshid Abdollahi Vayghan, University of Minnesota, 2003) discloses a multi-stage multiclass cost-sensitive classification model, developed using real-world sales opportunity data. The classification model is prototyped and validated with the real-world data and is shown to perform at par with human experts. Special considerations are given to improving its understandability and reducing its sensitivity to minor data changes. Additional experiments show that the multi-stage learning system cannot be replaced with a single stage learning system.

US Patent application No. 2006/0129447 (Dockery et al.) published on Jun. 15, 2006 discloses a business planning solution for sales force effectiveness in promoting products in a target market. The planning solution analyzes sales and market data to identify target market segments that are likely to respond to sales force activity. Business resources can then be allocated to optimize sales force activity. Detailed sales call plans can be generated. The business planning solution may be implemented as a computer software application on conventional stand alone or networked computer arrangements. For pharmaceutical industry applications, the software application is configured to process pharmaceutical market research data.

US Patent application No. 2006/0212337 (Vayghan et al.) published on Sep. 21, 2006 discloses a method (and system) of assigning a sales opportunity, includes creating an assignment model based on clustering historical sales opportunities, and providing a scoring mechanism on a plurality of sales agents for automatically optimizing an assignment of at least one sales opportunity to at least one of the plurality of sales agents.

US Patent application No. 2012/0095804 (Calabrese et al.) published on Apr. 19, 2012 discloses a sales optimization system includes a forecasting module to determine forecasts for sales metrics, an optimization module to determine recommended actions for achieving sales goals, and a user interface to generate scorecards indicating actual vales for the sales metrics, forecasts for the sales metrics, and the recommended actions to improve the sales metrics. The forecasting module determines quantifications for forecasting variables, and the forecasts are determined based on the forecasting variables. The optimization module determines factors estimated to have impacted the sales metrics, and the recommended actions based on the factors.

U.S. Pat. No. 7,424,440 (Gupta et al.) published on Sep. 9, 2008 discloses a system and method for forecasting the effects of a marketing decision on future sales by analyzing product sales strategies using archived sales data obtained from database files. The database files may be validated so as to insure their integrity. An initial sales profile is used with a defined analysis period to calculate an adjusted weekly sales value and an uplifted sales value is found using a selected uplift percentage. A corresponding profit is calculated based on the uplifted sales value. The method may include risk analysis performed to yield comparative graphical data and to provide for refinement of the previous analysis.

US Patent application No. 2009/0234722 (Evevsky) published on Sep. 17, 2009 discloses a method for increasing the conversion rate, or the ratio of the number of actual buyers to the number of site visitors, of an computer-implemented system such as an Internet e-commerce website. Shopping cart abandonment may be reduced though the disclosed method wherein filler items are suggested to the consumer in order to qualify the consumer for a promotional bonus, such as free shipping. By simplifying the consumer's task of selecting filler items, the consumer may be more likely to consummate the sale instead of abandoning the shopping cart to find a better deal elsewhere. In the event no suitable filler items can be identified, alternative promotions may be presented to the consumer, for example, reduced rate shipping.

U.S. Pat. No. 7,725,346 (Gruhl et al.) published on May 25, 2010 discloses a sales prediction system predicts sales from online public discussions. The system utilizes manually or automatically formulated predicates to capture subsets of postings in online public discussions. The system predicts spikes in sales rank based on online chatter. The system comprises automated algorithms that predict spikes in sales rank given a time series of counts of online discussions such as blog postings. The system utilizes a stateless model of customer behavior based on a series of states of excitation that are increasingly likely to lead to a purchase decision. The stateless model of customer behavior yields a predictor of sales rank spikes that is significantly more accurate than conventional techniques operating on sales rank data alone.

### GENERAL DESCRIPTION

According to a first aspect of the presently disclosed subject matter, there is provided a system for automatically generating a statistical model capable of providing probabilities of successful future interactions with one or more potential customers of a company, the system comprising at least one processor configured to: obtain a plurality of groups of values of corresponding parameters, each of the groups relating to a corresponding historical interaction with a corresponding customer of the company, wherein a meaning of at least one given parameter of the parameters of at least one group of the groups is unknown, and wherein at least one first group of the groups includes an indication of a successful corresponding historical interaction; and generate, using at least one of the groups, a value of the given parameter, the indication of a successful corresponding historical interaction and the indication of an unsuccessful corresponding historical interaction, a statistical model useable for providing probabilities of successful future interactions with the potential customers of the company.

In some cases the generate includes automatically generating at least one new parameter having a new parameter value based on the value of the given parameter and using the new parameter value for the generate.

In some cases at least one second group of the groups includes an indication of an unsuccessful corresponding historical interaction.

In some cases at least one value of parameter of the parameters contains internal data originating from data sources of the company.

In some cases at least one value of parameter of the parameters contains external data originating from data sources external to the company.

In some cases the processor is further configured to determine possible values for the given parameter and utilize the possible values for the generate.

In some cases the processor is further configured to: obtain one or more additional groups of additional values of corresponding parameters, relating to a corresponding potential customer of the potential customers; and apply the statistical model on each of the additional groups for calculating a probability of a successful future interaction with the corresponding potential client.

In some cases the generate a statistical model includes: grouping the groups of values of corresponding parameters to two or more clusters of groups; and generating, for each cluster, a corresponding cluster-based statistical model useable for providing probabilities of successful future interactions with the potential customers of the company.

In some cases the generate further includes performing data balancing on each cluster before generating the corresponding cluster-based statistical model.

In some cases at least one cluster includes a selected subset of values of corresponding parameters of at least one group of values of corresponding parameters of the groups of values of corresponding parameters.

In some cases the internal data is retrieved using schema query.

In some cases the processor is further configured to: update at least one value of the additional values of corresponding parameters of at least one of the additional groups giving rise to updated groups; and re-apply the statistical model on each of the updated groups for calculating a probability of a successful future interaction with the corresponding potential client.

In some cases at least a first value of the values contains unstructured data and at least a second value of the values contains structured data.

In some cases at least one value of the values is a person name and wherein the processor is further configured to determine the probabilities that a person having the person name matches one or more respective pre-defined categories.

In some cases at least one value of the values is indicative of an event and wherein the processor is further configured to determine the probabilities that the event matches one or more respective pre-defined event types.

According to a second aspect of the presently disclosed subject matter, there is provided a method for automatically generating a statistical model capable of providing probabilities of successful future interactions with one or more potential customers of a company, the method comprising: obtaining a plurality of groups of values of corresponding parameters, each of the groups relating to a corresponding historical interaction with a corresponding customer of the company, wherein a meaning of at least one given parameter of the parameters of at least one group of the groups is unknown, and wherein at least one first group of the groups includes an indication of a successful corresponding historical interaction; and generating, using at least one of the groups, a value of the given parameter, the indication of a successful corresponding historical interaction and the indication of an unsuccessful corresponding historical interaction, a statistical model useable for providing probabilities of successful future interactions with the potential customers of the company.

In some cases the generating includes automatically generating at least one new parameter having a new parameter value based on the value of the given parameter and using the new parameter value for the generate.

In some cases at least one second group of the groups includes an indication of an unsuccessful corresponding historical interaction.

In some cases at least one value of parameter of the parameters contains internal data originating from data sources of the company.

In some cases at least one value of parameter of the parameters contains external data originating from data sources external to the company.

In some cases the method further comprises determining possible values for the given parameter and utilize the possible values for the generate.

In some cases the method further comprises obtaining one or more additional groups of additional values of corresponding parameters, relating to a corresponding potential customer of the potential customers; and applying the statistical model on each of the additional groups for calculating a probability of a successful future interaction with the corresponding potential client.

In some cases the generating a statistical model includes: grouping the groups of values of corresponding parameters to two or more clusters of groups; and generating, for each cluster, a corresponding cluster-based statistical model useable for providing probabilities of successful future interactions with the potential customers of the company.

In some cases the generating a statistical model further includes performing data balancing on each cluster before generating the corresponding cluster-based statistical model.

In some cases at least one cluster includes a selected subset of values of corresponding parameters of at least one group of values of corresponding parameters of the groups of values of corresponding parameters.

In some cases the internal data is retrieved using schema query.

In some cases the method further comprises: updating at least one value of the additional values of corresponding parameters of at least one of the additional groups giving rise to updated groups; and re-applying the statistical model on each of the updated groups for calculating a probability of a successful future interaction with the corresponding potential client.

In some cases at least a first value of the values contains unstructured data and at least a second value of the values contains structured data.

In some cases at least one value of the values is a person name and further comprising determining the probabilities that a person having the person name matches one or more respective pre-defined categories.

In some cases at least one value of the values is indicative of an event and further comprising determining the probabilities that the event matches one or more respective pre-defined event types.

According to a third aspect of the presently disclosed subject matter, there is provided a computer program product comprising a computer useable medium having computer readable program code embodied therein for automatically generating a statistical model capable of providing probabilities of successful future interactions with one or more potential customers of a company, the computer program product comprising:

computer readable program code for causing the computer to obtain a plurality of groups of values of corresponding parameters, each of the groups relating to a corresponding historical interaction with a corresponding customer of the company, wherein a meaning of at least one given parameter of the parameters of at least one group of the groups is unknown, and wherein at least one first group of the groups includes an indication of a successful corresponding historical interaction; and

computer readable program code for causing the computer to generate, using at least one of the groups, a value of the given parameter, the indication of a successful corresponding historical interaction and the indication of an unsuccessful corresponding historical interaction, a statistical model useable for providing probabilities of successful future interactions with the potential customers of the company.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram schematically illustrating one example of an environment in which a system for predicting sales operates, in accordance with the presently disclosed subject matter;

FIG. 2 is a block diagram schematically illustrating one example of a system for predicting sales, in accordance with the presently disclosed subject matter;

FIG. 3 is a flowchart illustrating one example of a sequence of operations carried out for generating a statistical model capable of providing a user with probabilities of successful future interactions with one or more customers of the user and using the model for calculating a probability of a successful future interaction with the customers, in accordance with the presently disclosed subject matter;

FIG. 4 is a flowchart illustrating one example of a sequence of operations carried out for obtaining internal data, in accordance with the presently disclosed subject matter;

FIG. 5 is a flowchart illustrating one example of a sequence of operations carried out for generating a statistical model capable of providing a user with probabilities of successful future interactions with one or more customers of the user, in accordance with the presently disclosed subject matter; and

FIG. 6 is a flowchart illustrating one example of a sequence of operations carried out for performing a what-if analysis, in accordance with the presently disclosed subject matter.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “receiving”, “determining”, “generating”, “processing”, “filtering” or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a non-transitory computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

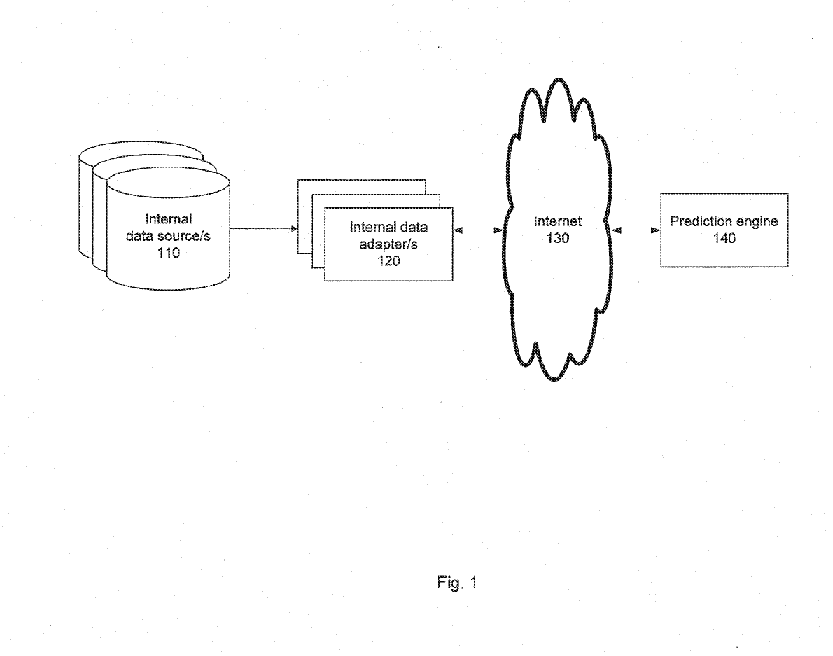

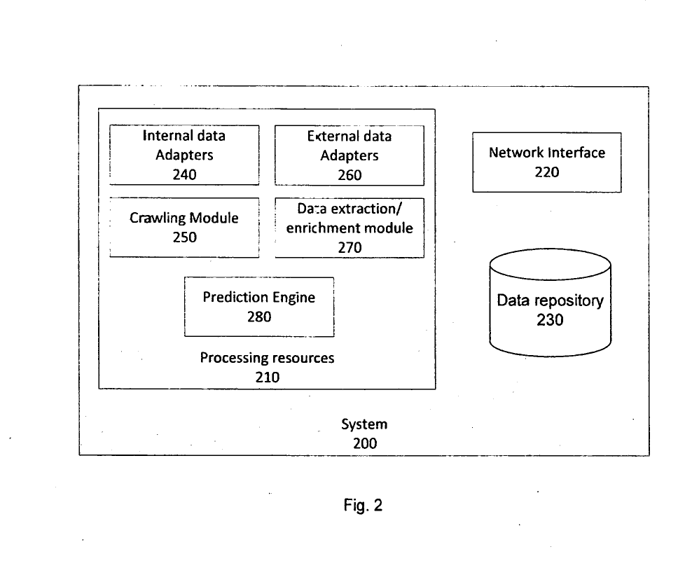

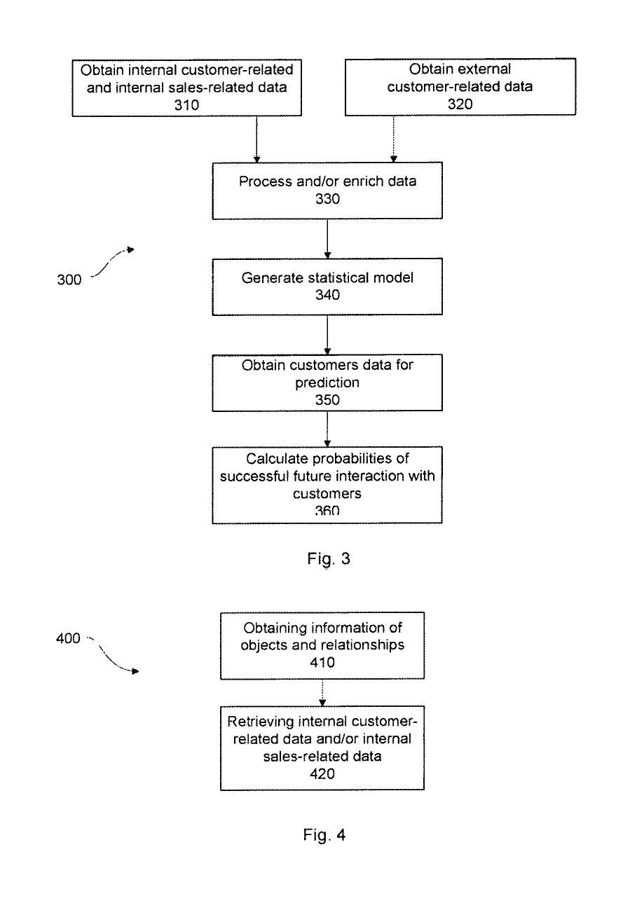

In embodiments of the presently disclosed subject matter, fewer, more and/or different stages than those shown in FIGS. 3-9 may be executed. In embodiments of the presently disclosed subject matter one or more stages illustrated in FIGS. 3-9 may be executed in a different order and/or one or more groups of stages may be executed simultaneously. FIGS. 1 and 2 illustrate a general schematic of the system architecture in accordance with an embodiment of the presently disclosed subject matter. Each module in FIGS. 1 and 2 can be made up of any combination of software, hardware and/or firmware that performs the functions as defined and explained herein. The modules in FIGS. 1 and 2 may be centralized in one location or dispersed over more than one location. In other embodiments of the presently disclosed subject matter, the system may comprise fewer, more, and/or different modules than those shown in FIGS. 1 and 2.

Bearing this in mind, attention is drawn to FIG. 1, showing a block diagram schematically illustrating one example of an environment in which a system for predicting sales operates, in accordance with the presently disclosed subject matter.

According to some examples of the presently disclosed subject matter, the system can include internal data adapters 120 configured to connect (e.g. utilizing various Application Programming Interfaces (APIs)) to various internal data sources 110 of a company (or any other entity) that is interested in predicting its sales (the company is referred to hereinafter as: “the Company” or “the Companies” in plural) and retrieve internal data therefrom.

In some cases, internal data sources 110 can be any system of the Company that comprises internal data such as a Customer Relationship Management (CRM) system or any other data source that comprises data relating inter alia to existing customers and/or potential customers of the Company, to actual and/or potential sales of the Company, to past/present/future marketing efforts of the Company, etc.

Internal data can include customer-related data and/or sales-related data and/or marketing-related data or any other type of data available from the internal data sources. In some cases, customer-related data can include various information relating to existing customers and/or potential customers of the Company; sale-related data can include various information relating to past and present sales data relating to sales made by the Company to its customers; and marketing-related data can include various information relating to past and present marketing efforts made by the

[symbol]

The system can also include a prediction engine 140 configured to receive the retrieved data (e.g. via the Internet 130 or in any other manner, including via a local network) analyze it, optionally along with additional data from other sources (including for example data generated by the system), as further detailed herein, and provide sales-related predictions to the Company.

It is to be noted that the system can provide the sales prediction as a service (as the prediction engine 140, and optionally one or more of the internal data adapters 120, can be installed on servers that are not controlled by the Company). In such cases, the system can provide the service to a plurality of Companies. In other cases, the entire system (including the internal data adapters 120 and the prediction engine 140) can be installed on-premise (on servers controlled by the Company). It is to be noted that any other architecture that enables the prediction engine 140 to receive the internal data (of a Company or Companies) and any additional data that is required for its operation (as detailed herein) can be employed as well.

In some cases, the prediction engine 140 can be further configured to provide the analysis results to the Company directly, or via the internal data adapters 120, or by any other means.

Attention is now drawn to FIG. 2, showing a block diagram schematically illustrating one example of a system for predicting sales, in accordance with the presently disclosed subject matter.

According to some examples of the presently disclosed subject matter, system 200 can comprise one or more processing resources 210. The one or more processing resources 210 can be a processing unit, a microprocessor, a microcontroller or any other computing device or module, including multiple and/or parallel and/or distributed processing units, which are adapted to independently or cooperatively process data for controlling relevant system 200 resources and for enabling operations related to system 200 resources.

System 200 can further comprise one or more network interfaces 220 (e.g. a network interface card or any other suitable device) for enabling system 200 components to communicate between themselves and/or with resources external to system 200 (e.g. internal data source/s 110, etc.).

According to some examples of the presently disclosed subject matter, system 200 can comprise (or be otherwise associated with) a data repository 230, configured to store data, including inter alia, internal data associated with one or more Companies.

In some cases, data repository 230 can be further configured to store external data retrieved from one or more “external data sources” that are external to the Company/Companies sources (e.g. data sources that contain data that cannot be retrieved from the Company's internal data sources, such as: existing and/or potential Company's customers' websites, social networks such as Facebook, Twitter, LinkedIn, etc., Wikipedia, Data.com, news and/or economy-related websites, demography-related websites, etc.). External data can include data that is related to one or more past customers and/or existing customers and/or one or more potential customers and/or information that is not necessarily related to the existing/potential customers but can have an effect on the interaction with one or more of the existing/potential customers (e.g. information of events that are not directly connected to the existing/potential customers, but can have an indirect effect on any interaction therewith).

In some cases, data repository 230 can be further configured to enable retrieval, update and deletion of all or part of the stored data.

It is to be noted that the data stored in the data repository 230 can enable creation and/or identification of groups of parameter values (each comprising for example a value of a corresponding parameter), each of the groups relating to a specific customer or potential customer, as further detailed below. Such groups of parameter values can contain internal data and/or external data, and optionally additional data as further detailed herein. It is to be noted that the group can be implemented using various data structures, such as arrays, or any other suitable data structure.

According to some examples of the presently disclosed subject matter, the processing resources 210 can include (or be otherwise associated with) one or more of the following modules: internal data adapters 240, crawling module 250, external data adapters 260, data extraction/enrichment module 270 and prediction engine 280.

In some cases, as indicated herein, the internal data adapters 240 can be configured to connect to various internal data sources 110 of a Company that is interested in predicting its sales and retrieve internal data including customer-related data and/or sales-related data and/or marketing-related data, and/or any other type of data therefrom. The retrieved internal data can be stored in the data repository 230.

In some cases, the crawling module 250 can be configured to retrieve external data from one or more external data sources directly, or utilizing external data adapters 260 configured to connect (e.g. utilizing various Application Programming Interfaces (APIs)) to the external data sources, or in any other suitable manner. The external data can include, inter alia, various information relating to past, current and potential customers of the Company, including, for example (non-limiting): customer's revenues, customer's geographic location/s and demographic information relating thereto, customer's micro-segmentation (e.g. the industry to which it belongs, its products, its vision, its innovation type, etc.), financial information relating to the customer, number of employees of the customer (e.g. the general number of employees, the number of employees in each department, the number of employees in each team, etc.), website patterns of the customer's website. In addition, the external data can include, inter alia, information relating to specific personnel working for the client, such as: names, current positions, past positions (for the customer and/or for other companies), social connections with other people, information indicative of the persons seniority, contact details (emails, phone numbers, social network accounts, etc.), etc. The external data can additionally or alternatively include data that is not necessarily related to the past/existing/potential customers but can have an effect on the interaction with one or more of the past/existing/potential customers (e.g. information of events that are not directly connected to the past/existing/potential customers, but can have an indirect effect on any interaction therewith).

In some cases, the data extraction/enrichment module 270 can be configured to automatically process all or part of the internal data and/or the external data. Such processing can include, for example, performing text analysis, natural language processing, etc. It is to be noted in this respect that parts of the internal data and/or the external data can be unstructured, and in some cases such unstructured data is transformed into structured data, e.g. as detailed herein.

In some cases, data extraction/enrichment module 270 can be configured to perform cleansing of all or part of the internal data and/or the external data, e.g. by identifying noisy data and smoothing out outliers present in the customer data (see, for example, Ben-Gal I., Outlier detection, In: Maimon O. and Rockach L. (Eds.) Data Mining and Knowledge Discovery Handbook: A Complete Guide for Practitioners and Researchers,” Kluwer Academic Publishers, 2005, ISBN 0-387-24435-2, which is incorporated herein by reference).

In some cases, data extraction/enrichment module 270 can be configured to generate additional data based on the raw data (the data extracted from the internal and/or external data sources) and/or on the parts extracted from the data by it, e.g. using various statistical calculations. For example, when certain temporal numeric data is identified (e.g. a dollar amount of past deals), an average (e.g. an average dollar amount of past deals) or a forecast of a following number (e.g. a forecast of the next deal dollar amount) can be calculated, etc.

In some cases, prediction engine 280 can be configured to obtain a first set of groups (a groups is also referred to herein, interchangeably, as an “Entity” or “Entities” in plural) of parameter values (each comprising for example a value of a corresponding parameter), each of the groups including at least an indication of a certain customer or potential customer to which they relate. In some cases, at least one of the groups of the first set can include an indication of a first historical sale attempt to which it relates and an indication of a successful result of the first historical sale attempt. In some cases, at least one other group of the first set of groups can include an indication of a second historical sale attempt to which it relates and an indication of a unsuccessful result of the second historical sale attempt.

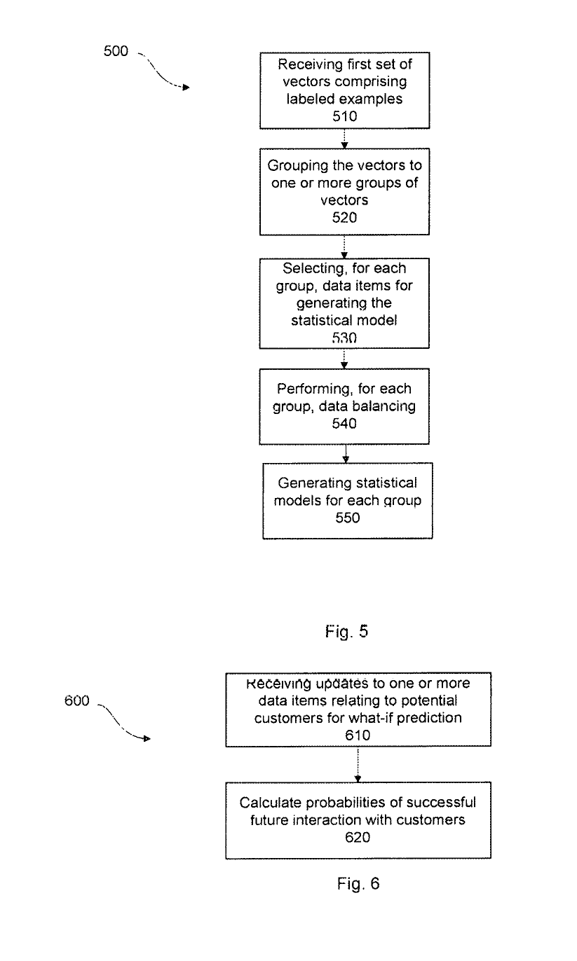

In some cases, the first set of groups can be based on the internal data and/or the external data, including any such data that has been manipulated by the data extraction/enrichment module 270 as detailed herein. In some cases the decision what part/s of the data will be contained in the groups can be manual (e.g. pre-defined) and/or automatic (e.g. as further detailed herein, inter alia with respect to FIG. 5). In some cases, the decision can depend on the type of the required statistical model or the type of the required prediction, as further detailed herein.

In some cases, the first set of groups can be created by the prediction engine 280. In other cases, the first set of groups can be created by any other component of system 200.

Based on the first set of groups, the prediction engine 280 can be configured to create one or more statistical models (using Neural Networks, Support Vector Machine, or any other known and/or specifically designed solution), each capable of providing probabilities of successful future interaction (e.g. sale) with the customer (see, for example, S. B. Kotsianitis, Supervised Machine Learning: A Review of Classification Techniques, Informatica 31:249-268 (2007), which is incorporated herein by reference). Some examples of statistical models can include models that can provide lead prediction, opportunity prediction, churns prediction, etc. In some cases the statistical model/s can be updated periodically (e.g. every pre-determined time window), in a continuous manner, or manually (e.g. upon a request from a user of the system 200).

The prediction engine 280 can be configured to generate multiple types of statistical models, for example based on the stage of the sales: lead prediction, opportunity (e.g. a qualified lead) prediction, churns prediction, etc.

In some cases, some of the statistical models can require the groups to contain at least one additional value of an additional parameter over the groups required by other statistical models.

In some cases, prediction engine 280 can be configured to receive a second set comprising one or more groups of parameter values (each comprising for example a value of a corresponding parameter) relating to potential and/or existing customers, apply a corresponding (e.g. based on the stage of the sales) statistical model thereon, and provide a user of the system 200 with probabilities of successful future interaction (e.g. sale) with the customer and/or with recommendations of actions to be taken in order to increase the probability of a successful future interaction with the customer (e.g. based on the stage of the sales—closing a deal, increasing customer satisfaction, etc.).

Having described the system, attention is now drawn to FIG. 3, showing a flowchart illustrating one example of a sequence of operations carried out for generating a statistical model capable of providing a user with probabilities of successful future interactions with one or more customers of the user and using the model for calculating a probability of a successful future interaction with the customers, in accordance with the presently disclosed subject matter.

According to some examples of the presently disclosed subject matter, system 200 can be configured to perform a prediction process 300. For that purpose, according to some examples of the presently disclosed subject matter, system 200 can be configured to connect (e.g. utilizing the internal data adapters 240) to various internal data sources 110 of a Company that is interested in predicting its sales and retrieve internal data including internal customer-related data and/or internal sales-related data and/or marketing-related data and/or any other type of data therefrom (block 310), as further detailed herein, inter alia with respect to FIG. 4. As indicated herein, the retrieved data can be stored in the data repository 230.

In some cases, system 200 can be configured to retrieve (e.g. utilizing the crawling module 250) external data from one or more external data sources (block 320). In some cases, such data can be retrieved by the crawling module 250 directly, or utilizing external data adapters 260 configured to connect (e.g. utilizing various Application Programming Interfaces (APIs)) to the external data sources, or in any other suitable manner.

As indicated herein, the external data can include, inter alia, various information relating to past, current and potential customers of the Company, including, for example (non-limiting): customer's revenues, customer's geographic location/s and demographic information relating thereto, customer's micro-segmentation (e.g. the industry to which it belongs, its products, its vision, its innovation type, etc.), financial information relating to the customer, number of employees of the customer (e.g. the general number of employees, the number of employees in each department, the number of employees in each team, etc.), website patterns of the customer's website. In addition, the external data can include, inter alia, information relating to specific personnel working for the client, such as: names, current positions, past positions (for the customer and/or for other companies), social connections with other people, information indicative of the persons seniority, contact details (emails, phone numbers, social network accounts, etc.), etc.

The external data can additionally or alternatively include data that is not necessarily related to the past/existing/potential customers but can have an effect on the interaction with one or more of the past/existing/potential customers (e.g. information of events that are not directly connected to the past/existing/potential customers, but can have an indirect effect on any interaction therewith)

As indicated herein, the retrieved data can be stored in the data repository 230.

In some cases, system 200 can be configured to automatically process and/or enrich the data (e.g. utilizing the data extraction/enrichment module 270) (block 330). In some cases, the result of the data processing and/or enrichment is a first set of groups of parameter values (each comprising for example a value of a corresponding parameter) that can be used for generating a statistical model capable of providing a user with probabilities of successful future interactions with one or more customers of the user, as further detailed herein. In some cases, at least one of the groups of the first set can include an indication of a first historical sale attempt to which it relates and an indication of a successful result of the first sale attempt. In some cases, at least one other group of the first set of groups can include an indication of a second historical sale attempt to which it relates and an indication of an unsuccessful result of the second sale attempt. It is to be noted that in some cases, the semantics (e.g. the meaning) of one or more of the parameters of the first set of groups (and the parameter values corresponding to such parameter) is unknown.

In some cases, the data processing can include performing, for example, text analysis and/or natural language processing, etc., for example using world knowledge (that can originate from various sources such as Wikipedia, Dictionary.com, etc.) and/or common sense ontologies that are specifically designed for these purposes. For this purpose, system 200 can be configured to utilize a semantic engine that can be configured to perform one or more of the following: sentence chunking, tokenization, part-of-speech identification, canonization, inference rules activation, etc.

It is to be noted that in some cases, the semantics (e.g. the meaning) of at least part of the internal data and/or the external data is unknown. In such cases, the system 200 can be configured to determine the type of the data (numeric, discrete (including its possible values), date, etc.), e.g. automatically using the schema query, by performing any type of analysis on the data, or in any other manner.

In some cases, the system 200 can be configured to determine possible values for the parameters having an unknown semantics.

It is to be noted that the data processing can include automatically performing data processing (e.g. time series analysis, text analysis, etc.) of at least one parameter having an unknown semantics. For example, the system can take a certain parameter and identify that it contains numerical values indicative of the amounts of the deals made with a certain customer. Without understanding what this field means, the system 200 can generate a set of new parameters and/or parameter values, e.g. the prediction of the next value of the amount using time series analysis, the mean and the variance of the amounts, etc. Similarly, the system can infer that a certain parameter contains text, e.g. email correspondences with a potential customer, and apply other transformations thereon, such as sentiment analysis, etc. In some cases, the system 200 can also take two potential fields (e.g. the weight and height of the potential customer) and divide/multiply or perform any other manipulation thereon in order to generate one or more new parameters and/or parameter values. In general, the system 200 can be configured to receive subsets of fields and an indication of their types, and apply a predefined set of transformations. The set if predefined, but the data on which it will be applied is not (only the types it can be applied on). As this creates a large set of values, a process of feature selection can be performed as part of the prediction, as further detailed herein.

In some cases, the data processing can include cleansing of all or part of the internal data and/or the external data, e.g. by identifying noisy data and smoothing out outliers present in the data.

In some cases, the data enrichment can include generating additional data that can be used as parameter values (each comprising for example a value of a corresponding parameter) of the first set of groups for generating the statistical model, based on all or part of the internal data and/or the external data. For that purpose, the system 200 can be configured to perform, for example, text analysis and/or natural language processing and/or semantic modeling (understanding the meaning of a text) and/or sentiment analysis (identifying a sentiment in a text such as an email, an article, text messages, etc.), etc. e.g. using the semantic engine, and/or various statistical calculations on the data, e.g. when certain temporal numeric data is identified (e.g. a dollar amount of past deals) an average (e.g. an average dollar amount of past deals) or a forecast of a following number (e.g. a forecast of the next deal dollar amount) can be calculated, etc.

In some cases, the data processing can include a person name or company name disambiguation process. In such cases, when the system 200 identifies a certain part of the data as a name of a person or a name of a company, the disambiguation enables identifying a specific person or company according to the name (e.g. using any known method or technique). For example (non-limiting), assuming that information of a certain person includes that the person is named “John Doe”, that “John Doe” works for “Microsoft” and that “John Doe” uses, at least sometimes, a given Internet Protocol (IP) address, a certain social network (e.g. LinkedIn) can indicate that there are two users having the name “John Doe” and working for “Microsoft”, one is from the United States of America (USA) and the other is from Europe. Analysis of the IP address can be performed in order to determine whether the relevant “John Doe” is the one from the USA or the one from Europe.

In some cases, the data processing can include categorizing the identified personnel, for example as a technical person, a sales person, a manager, etc. The categorization can be performed by a persona classifier. The persona classifier can be a statistical model generated using a set of pre-defined labeled examples indicative of various persona categories for that purpose. The statistical model in this case can be configured to receive information associated with a person (including in some cases information indicative of its position) and determine the probabilities that the person matches one or more respective pre-defined categories (e.g. sales, marketing, technical, etc.).

In some cases, the data enrichment can include event detection. In such cases, the system 200 can be configured to scan the internal data and/or the external data and identify information that is indicative of one or more events that may have an effect on the future interaction with one or more of the customers. Such events can be events that are directly related to one or more of the customers (e.g. a Merger and Acquisition (M&A) event, a launch of a new product, a personnel change, etc;) or indirectly related to one or more of the customers (a market trend, a political change, etc.). The event classification can be performed by an event classifier. The event classifier can be a statistical model generated using a set of pre-defined labeled examples indicative of various pre-defined event types for that purpose. The statistical model in this case can be configured to receive information associated with an event and determine the probabilities that the event matches one or more respective pre-defined event types.

Returning to the prediction process 300, according to some examples of the presently disclosed subject matter, system 200 can be configured to utilize the first set of groups, including the one or more parameter having unknown semantics (e.g. unknown meaning), in order to generate one or more statistical models capable of providing a user with probabilities of successful future interactions with one or more customers of the user (block 340), as further detailed herein, inter alia with respect to FIG. 5. It is to be noted that in some cases, the values that correspond to one or more parameter having unknown semantics (e.g. unknown meaning) are positively used for generating the statistical model.

In some cases, system 200 can be configured to receive a second set of groups of parameter values (each comprising for example a value of a corresponding parameter) relating to potential and/or existing customers (block 350), apply a corresponding (e.g. based on the stage of the sales) statistical model thereon, and calculate probabilities of successful future interaction (e.g. sale) with the customer and/or with recommendations of actions to be taken in order to increase the probability of a successful future interaction with the customer (e.g. based on the stage of the sales—closing a deal, increasing customer satisfaction, etc.) (block 360).

It is to be noted that, with reference to FIG. 3, some of the blocks can be integrated into a consolidated block or can be broken down to a few blocks and/or other blocks may be added. Furthermore, in some cases, the blocks can be performed in a different order than described herein (for example, block 310 can be performed before block 320 and vice versa, etc.). It is to be further noted that some of the blocks are optional. It should be also noted that whilst the flow diagram is described also with reference to the system elements that realizes them, this is by no means binding, and the blocks can be performed by elements other than those described herein.

Having described the prediction process 300, attention is now drawn to FIG. 4, showing a flowchart illustrating one example of a sequence of operations carried out for obtaining internal data, in accordance with the presently disclosed subject matter.

According to some examples of the presently disclosed subject matter, system 200 can be configured to perform an internal data extraction process 400. For that purpose, according to some examples of the presently disclosed subject matter, system 200 can be configured to obtain (e.g. utilizing the internal data adapters 240) information of the objects stored in various internal data sources 110 (e.g. a Customer Relationship Management (CRM) system or any other data source that comprises data relating inter alia to existing customers and/or potential customers of the Company, to actual and/or potential sales of the Company, to past/present/future marketing efforts of the Company, etc.) of the Company and the relationships between the objects (block 410). In some cases the information can be obtained automatically, e.g. using a schema query (e.g. “define” in SalesForce CRM, etc.) or an alternative algorithm that is configured to obtain the information. It is to be noted that the information can optionally be obtained in any other manner, including manually.

In some cases, system 200 can be configured to utilize the information of the objects and relationships for retrieving internal data, including internal customer-related data and/or internal sales-related data and/or marketing-related data or any other type of data available from the various internal data sources 110 (block 420).

It is to be noted that, with reference to FIG. 4, the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

Attention is now drawn to FIG. 5, showing a flowchart illustrating one example of a sequence of operations carried out for generating a statistical model capable of providing a user with probabilities of successful future interactions with one or more customers of the user, in accordance with the presently disclosed subject matter.

According to some examples of the presently disclosed subject matter, system 200 can be configured to perform (e.g. utilizing the prediction engine 280) a statistical model generation process 500. For that purpose, in some cases, system 200 can be configured to receive a first set of groups of parameter values (each comprising for example a value of a corresponding parameter), each of the groups including at least an indication of a certain customer or potential customer to which they relate (in other words, the parameter values of each group is associated with a specific customer or potential customer) (block 510). In some cases, at least one group of the groups used by the statistical model generation process 500 is labeled as a positive example (meaning that it represents a successful interaction with the client). In some cases at least one other group of the groups used by the statistical model generation process 500 is labeled as a negative example (meaning that it represents an unsuccessful interaction with the client). If we take the process of lead qualification as an example, the process will have the qualified leads as positive examples and the unqualified leads as negative examples.

In some cases, the system 200 can be configured to cluster the groups of the first set of groups into one or more clusters of groups, each comprising two or more groups (block 520). In some cases the clustering can be performed randomly, whereas in other cases the clustering can be performed according to a pre-determined rule (e.g. a rule defining the amount of positive examples and/or the amount of negative examples for each group, etc.). In other cases the clustering can be performed according to the origin of the data (e.g. data originating from a data source that contains data relating to leads will be clustered as a first cluster, data originating from a data source that contains data relating to opportunities will be clustered as a second cluster, etc.)

In some cases, for each cluster of groups or for some of the clusters, the system 200 can be configured to select a subset of the parameter values to be used for generating the statistical model (block 530). In some cases the selection is based on a statistical test that checks multiple, and in some cases each, possible combinations of the parameter values in order to determine whether the positive and negative examples can be identified with a certain degree of certainty (e.g. a predefined threshold). If it does—the feature (the parameter) can be selected and if not the feature (the parameter) will not be used. In some cases the statistical test can be chi square analysis (see, for example, Chernoff, H.; Lehmann, E. L. (1954). “The Use of Maximum Likelihood Estimates in χ² Tests for Goodness of Fit”, The Annals of Mathematical Statistics 25 (3): 579-586).

In some cases, for each cluster of groups or for some of the clusters, the system 200 can be configured to perform data balancing (block 540) in order to re-weight the data based on the distribution (e.g. making sure to have a similar amount of positive and negative examples, etc.). In some cases the data balancing can include adding one or more dummy groups as positive or negative examples in order to balance the amount of negative and positive examples. Alternatively or additionally, the balancing can be performed by providing weights to the positive and negative examples in order to compensate for the difference in the number of positive examples versos the number of negative examples.

In some cases, for each cluster of groups or for some of the clusters, the system 200 can be configured to generate a corresponding statistical model (e.g. a decision tree, or any other suitable statistical model) that is capable of providing a user with probabilities of successful future interactions with one or more customers of the Company (block 550). In some cases, as part of the generation of the statistical model, the system 200 can be configured to perform ensemble learning using any method or technique (see, for example: “A decision-theoretic generalization of on-line learning and an application to boosting”, Journal of Computer and System Sciences 55. 1997) (block 560).

During prediction, the statistical models can classify a second set of groups of parameter values (each comprising for example a value of a corresponding parameter) relating to potential and/or existing customers and provide a corresponding prediction for each group of the second set of groups. Looking at the process of lead qualification as an example, the statistical model will at this point provide the likelihood of each lead (represented by a group in the second set of groups) to become an opportunity or a customer. It is to be noted that the system 200 can determine what statistical model to use, e.g. based on the association of the groups of parameter values with a given statistical model (e.g. for a group of parameter values that is related to a lead the system 200 will use the statistical model that is based on data originating from a data source that contains data relating to leads, etc.).

It is to be noted that, with reference to FIG. 5, some of the blocks can be integrated into a consolidated block or can be broken down to a few blocks and/or other blocks may be added. Furthermore, in some cases, the blocks can be performed in a different order than described herein (for example, block 540 can be performed before block 530, etc.). It is to be further noted that some of the blocks are optional. It should be also noted that whilst the flow diagram is described also with reference to the system elements that realizes them, this is by no means binding, and the blocks can be performed by elements other than those described herein.

Turning to FIG. 6, there is shown a flowchart illustrating one example of a sequence of operations carried out for performing a what-if analysis, in accordance with the presently disclosed subject matter.

According to some examples of the presently disclosed subject matter, system 200 can be configured to perform (e.g. utilizing the prediction engine 280) a what-if analysis process 600. For that purpose, in some cases, system 200 can be configured to receive updates to one or more parameter values within one or more of the groups within a second set of groups of parameter values that relate to potential and/or existing customers of the Company (block 610). Some examples of such updates can include, for example, adding a discount, adding information of another person form a potential customer's organization to push the deal forward, offering a different product to the potential customer, etc.

After performing the updates to the one or more parameter values, the system 200 can be configured to calculate the probabilities of successful future interaction, taking into account the updates (block 620).

It is to be noted that, with reference to FIG. 6, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1-32. (canceled)

33. A system for automatically generating a statistical model capable of providing probabilities of successful future interactions with one or more potential customers of a company, the system comprising at least one processor configured to:
obtain a plurality of groups of values of corresponding parameters, each of the groups relating to a corresponding historical interaction with a corresponding customer of the company, wherein a meaning of at least one given parameter of the parameters of at least one group of the groups is unknown, and wherein at least one first group of the groups includes an indication of a successful corresponding historical interaction; and
generate, using at least one of the groups, a value of the given parameter, the indication of a successful corresponding historical interaction and the indication of an unsuccessful corresponding historical interaction, a statistical model useable for providing probabilities of successful future interactions with the potential customers of the company.

34. The system of claim 33 wherein said generate includes automatically generating at least one new parameter having a new parameter value based on the value of the given parameter and using the new parameter value for said generate.

35. The system of claim 33 wherein at least one second group of the groups includes an indication of an unsuccessful corresponding historical interaction.

36. The system of claim 33, wherein at least one value of parameter of the parameters contains internal data originating from data sources of the company, and at least one value of parameter of the parameters contains external data originating from data sources external to the company.

37. The system of claim 33, wherein said processor is further configured to determine possible values for the given parameter and utilize the possible values for said generate.

38. The system of claim 33, wherein said processor is further configured to:
obtain one or more additional groups of additional values of corresponding parameters, relating to a corresponding potential customer of the potential customers; and
apply the statistical model on each of the additional groups for calculating a probability of a successful future interaction with the corresponding potential client.

39. The system of claim 33, wherein said generate a statistical model includes:
grouping the groups of values of corresponding parameters to two or more clusters of groups; and
generating, for each cluster, a corresponding cluster-based statistical model useable for providing probabilities of successful future interactions with the potential customers of the company.

40. The system of claim 39, wherein said generate further includes performing data balancing on each cluster before generating the corresponding cluster-based statistical model.

41. The system of claim 39, wherein at least one cluster includes a selected subset of values of corresponding parameters of at least one group of values of corresponding parameters of the groups of values of corresponding parameters.

42. The system of claim 38, wherein said processor is further configured to:
update at least one value of the additional values of corresponding parameters of at least one of the additional groups giving rise to updated groups; and
re-apply the statistical model on each of the updated groups for calculating a probability of a successful future interaction with the corresponding potential client.

43. A method for automatically generating a statistical model capable of providing probabilities of successful future interactions with one or more potential customers of a company, the method comprising:
obtaining a plurality of groups of values of corresponding parameters, each of the groups relating to a corresponding historical interaction with a corresponding customer of the company, wherein a meaning of at least one given parameter of the parameters of at least one group of the groups is unknown, and wherein at least one first group of the groups includes an indication of a successful corresponding historical interaction; and
generating, using at least one of the groups, a value of the given parameter, the indication of a successful corresponding historical interaction and the indication of an unsuccessful corresponding historical interaction, a statistical model useable for providing probabilities of successful future interactions with the potential customers of the company.

44. The method of claim 43 wherein said generating includes automatically generating at least one new parameter having a new parameter value based on the value of the given parameter and using the new parameter value for said generate.

45. The method of claim 43 wherein at least one second group of the groups includes an indication of an unsuccessful corresponding historical interaction.

46. The method of claim 43, further comprising determining possible values for the given parameter and utilize the possible values for said generate.

47. The method of claim 43, wherein said processor is further configured to:
obtaining one or more additional groups of additional values of corresponding parameters, relating to a corresponding potential customer of the potential customers; and
applying the statistical model on each of the additional groups for calculating a probability of a successful future interaction with the corresponding potential client.

48. The method of claim 43, wherein said generating a statistical model includes:
grouping the groups of values of corresponding parameters to two or more clusters of groups; and
generating, for each cluster, a corresponding cluster-based statistical model useable for providing probabilities of successful future interactions with the potential customers of the company.

49. The method of claim 48, wherein the step of generating further includes performing data balancing on each cluster before generating the corresponding cluster-based statistical model.

50. The method of claim 48, wherein at least one cluster includes a selected subset of values of corresponding parameters of at least one group of values of corresponding parameters of the groups of values of corresponding parameters.

51. The method of claim 47, further comprising:
updating at least one value of the additional values of corresponding parameters of at least one of the additional groups giving rise to updated groups; and
re-applying the statistical model on each of the updated groups for calculating a probability of a successful future interaction with the corresponding potential client.

52. A program storage device readable by a machine, tangibly embodying a program of instructions executable by the machine to perform method steps of:
obtaining a plurality of groups of value of the values parameters, each of the groups relating to a corresponding historical interaction with a corresponding customer of the company, wherein a meaning of at least one given parameter of the parameters of at least one group of the groups is unknown, and wherein at least one first group of the groups includes an indication of a successful corresponding historical interaction; and
generating, using at least one of the groups, a value of the given parameter, the indication of a successful corresponding historical interaction and the indication of an unsuccessful corresponding historical interaction, a statistical model useable for providing probabilities of successful future interactions with the potential customers of the company.
